(19) United States
(12) Patent Application Publication
(10) Pub. No.: US 2004/0125976 A1
(43) Pub. Date: Jul. 1, 2004

(54) Headphones or earmuffs with a user operated mechanical device that controls the volume of exterior sound entering the ear of the user

(76) Inventor: Brian Scott Reneker, Wyoming, MI (US)

Correspondence Address: Brian Scott Reneker, 3754 Parkland SW, Wyoming, MI, 49509, US

(21) Appl. No.: 10/331,067

(22) Filed: Dec. 30, 2002

(51) Int. Cl. H04R 25/00

(52) U.S. Cl. 381/372; 381/371; 381/373; 381/370

(57) ABSTRACT

The present invention is a headphone or earmuff unit that has two main parts. The first main part is the stationary enclosure, which fits over the ear of the user. This part also has holes in it for the passage of exterior sound. The second main part is the movable enclosure, which fits over the holes of the stationary enclosure. Both enclosures are padded for sound suppression. The two enclosures are tied together by a screw mechanism with a knob. When the knob is turned the enclosures separate. This allows exterior sound to enter the stationary enclosure, and thus the ear of the user, in a controlled manner.

### BACKGROUND OF THE INVENTION

One field of endeavor for this invention is the electronic stereo headphone industry. Other possible fields of endeavor include the acoustic musical instrument accessory industry, particularly the drums and percussion accessory industry, and the hearing protection industry.

The present invention relates generally to improvements in headphone technology used in high decibel sound environments such as playing an acoustic musical instrument, particularly drums and percussion. The present invention also relates generally to improvements in earmuff hearing protection technology used in high decibel sound environments such as industrial factories.

More particularly the present invention relates to the user mechanically controlling the level of exterior sound transmitted to the ear through the headphones or earmuffs. If used in headphones the present invention would allow a musician that plays an acoustic musical instrument, particularly drums and percussion, to practice their instrument to recorded music and obtain a perfect mix and volume level of the music from the speakers in the headphones and the instrument being played. This is achieved by first suppressing the exterior sound entering the headphones and then the user controlling both the volume of the music being played and the volume of the exterior sound of the acoustic instrument.

This is important because current technology does not allow for this. With current headphone technology the headphones either have too much acoustic padding or not enough. If there is too much acoustic padding the acoustic musical instrument, particularly drums and percussion, sounds muffled and tonal quality is lost. Because of this the musician cannot hear what he or she is playing.

If there is not enough acoustic padding the acoustic musical instrument, particularly drums and percussion, sounds too loud. Because of this the musician has to increase the volume of the music to an uncomfortable level in order to hear the music. This in time actually causes hearing damage.

If the present invention were used in earmuffs it would allow the user to control the amount of protection needed for a given environment. This control would allow the user too have hearing protection and still be able to hear critical information the user may need such as co-workers, warning alarms and emergency situations.

### BREIF SUMMARY OF THE INVENTION

The present invention has been developed to overcome the disadvantages described in the Background of the Invention.

It is the objective of the present invention to provide improved headphone technology and earmuff hearing protection technology by first suppressing the amount of exterior sound to the ear of the user then providing a user operated mechanical device that controls the volume of exterior sound entering the ear of the user.

In accomplishing the above objective, the present invention includes a headphone or earmuff that has two parts, a stationary enclosure and a movable enclosure. The stationary enclosure fits over the ear of the user and has holes in it to allow for the passage of exterior sound. The movable enclosure is placed over the stationary enclosure, which covers the holes. Both enclosures are acoustically padded for sound suppression. There are also two foam rubber gaskets between the two enclosures in order to make a good seal when the enclosures are together. The two enclosures are connected with a screw mechanism that when turned opens the enclosures in varying degrees. This allows for the passage of exterior sound to the ear of the user through the holes in the stationary enclosure in varying degrees. If the present invention were used in headphones the exterior sound would then mix with the music from the speakers in the headphones. By controlling both the volume of music and the volume of exterior sound the user is able to obtain a perfect mix of music and the acoustic instrument being played at a desired volume level.

### BREIF DESCRIPTION OF THE SEVERAL VIEWS OF THE DRAWING

FIG. 1 depicts a perspective view of a typical set of headphone or earmuff (without the speaker) assemblies. This includes two headphone or earmuff units, one for each ear of the user. This perspective view FIG. 1 also depicts the present invention used for both headphone or earmuff units.

FIG. 2 depicts an enlarged perspective view of one typical headphone or earmuff assembly as established in FIG. 1. This enlarged perspective view FIG. 2 also depicts the present invention used in one typical headphone or earmuff unit. This enlarged perspective view FIG. 2 also depicts the view orientation used for FIG. 3, 4&5.

FIG. 3 depicts the front view of one typical headphone or earmuff assembly as established in FIG. 2. This front view FIG. 3 also depicts the present invention used in one typical headphone or earmuff unit.

FIG. 4 depicts the ear or left side view of one typical headphone or earmuff assembly as established in FIG. 2. This ear or the left side view FIG. 4 also depicts the present invention used in one typical headphone or earmuff unit.

FIG. 5 depicts the exterior or right side view of one typical headphone or earmuff assembly as established in FIG. 2. This exterior or right side view FIG. 5 also depicts the present invention used in one typical headphone or earmuff unit. This exterior or right side view FIG. 5 also depicts the plane upon which the sectional view AA shown in FIG. 6 is taken.

FIG. 6 depicts a sectional view labeled AA of one typical headphone or earmuff unit with the present invention as established in FIG. 5. This sectional view shows the present invention in the fully open position and depicts the mechanical parts and material composition of the present invention.

### DETAILED DESCRIPTION OF THE INVENTION

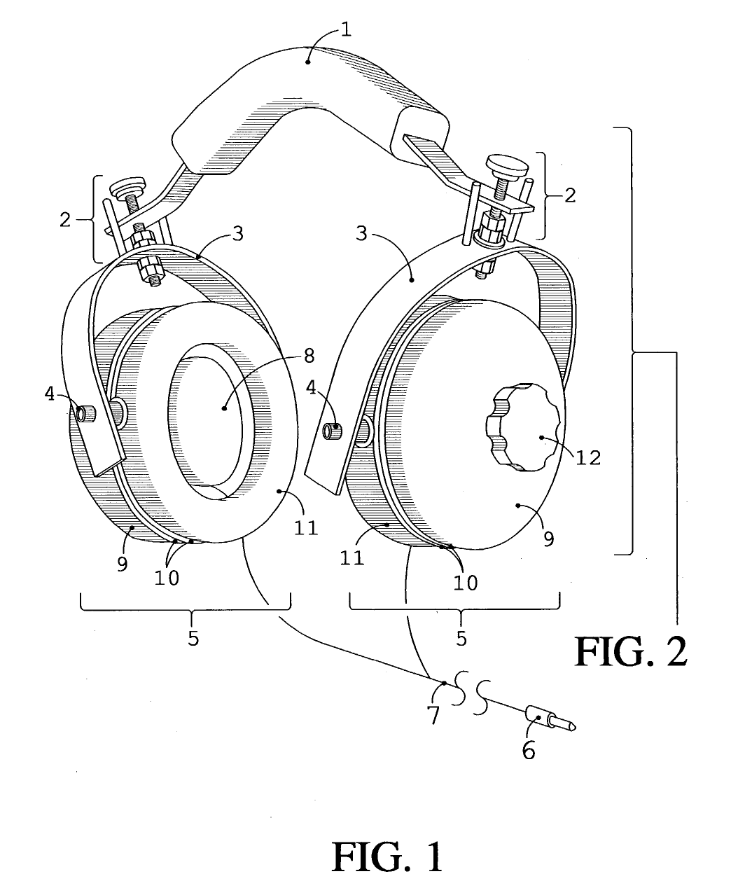

FIG. 1 depicts a perspective view of a typical set of headphone or earmuff (without the speaker) assemblies. This perspective view FIG. 1 depicts: one aluminum connector bar with a foam rubber headrest 1, Two pivoting headphone adjustment assemblies 2, Two aluminum headphone mounting brackets 3, two pivoting bracket to headphone connection assemblies 4, one speaker 8 (for headphones only), one stereo headphone jack 6 and speaker cord 7. All of which is considered prior art.

This perspective view FIG. 1 also depicts two headphone or earmuff units 5 (one for each ear of the user) with the present invention shown in both units. This includes: two movable headphone or earmuff enclosure assemblies 9 (one per headphone or earmuff), four foam rubber control gaskets 10 (two per headphone or earmuff), two stationary headphone or earmuff enclosure assemblies 11 (one per headphone or earmuff) and one plastic control knob 12.

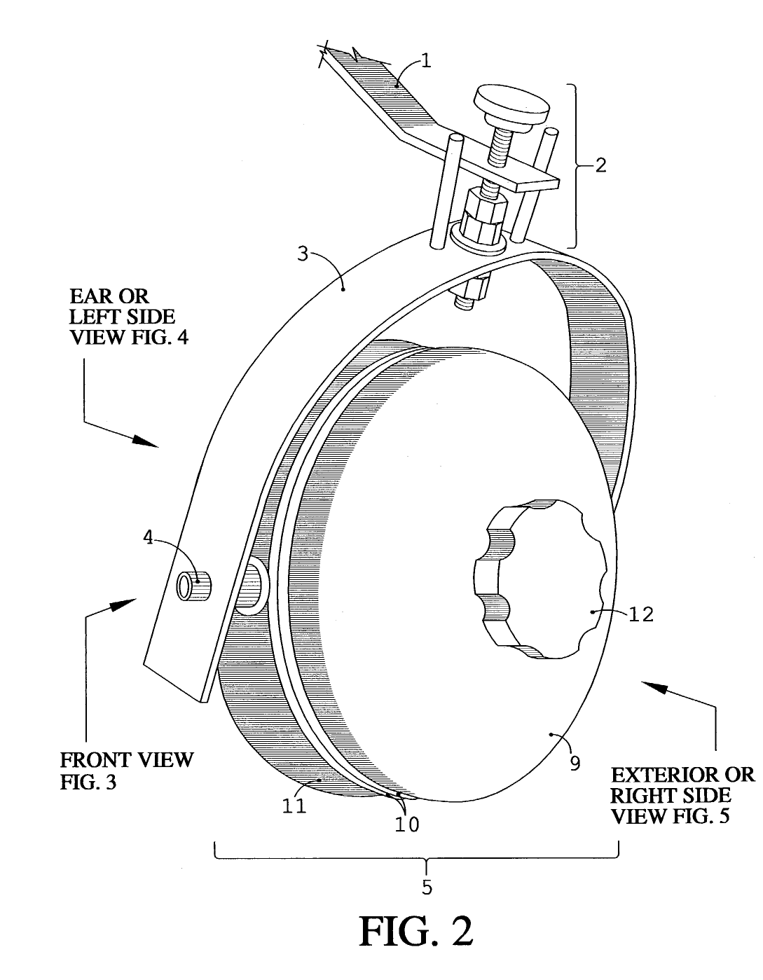

FIG. 2 depicts an enlarged perspective view of one typical headphone or earmuff assembly as established in FIG. 1. This enlarged perspective view FIG. 2 depicts: one aluminum connector bar with a foam rubber headrest 1, one pivoting headphone adjustment assembly 2, one aluminum headphone mounting bracket 3 and one pivoting bracket to headphone connection assembly 4. All of which is considered prior art.

This enlarged perspective view FIG. 2 also depicts the present invention used in one typical headphone or earmuff unit 5. This includes: one movable headphone or earmuff enclosure assembly 9, two foam rubber control gaskets 10, one stationary headphone or earmuff enclosure assembly 11 and one plastic control knob 12.

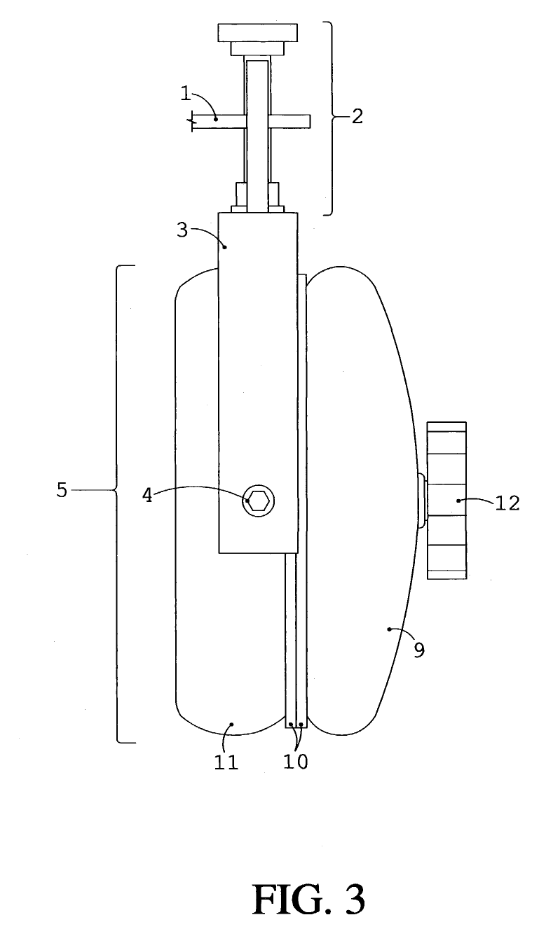

This enlarged perspective view FIG. 2 also depicts the view orientations used in FIG. 3, 4 and 5. This includes: the front view, ear or left side view and outside or right side view.

FIG. 3 depicts the front view of one typical headphone or earmuff assembly as established in FIG. 2. This front view FIG. 3 depicts: one aluminum connector bar 1, one pivoting headphone adjustment assembly 2, one headphone mounting bracket 3 and one pivoting bracket to headphone connection assembly 4. All of which is considered prior art.

This front view FIG. 3 also depicts the present invention used in one typical headphone or earmuff unit 5. This includes: one movable headphone enclosure assembly 9, two foam rubber control gaskets 10, one stationary headphone enclosure assembly 11 and one plastic control knob 12.

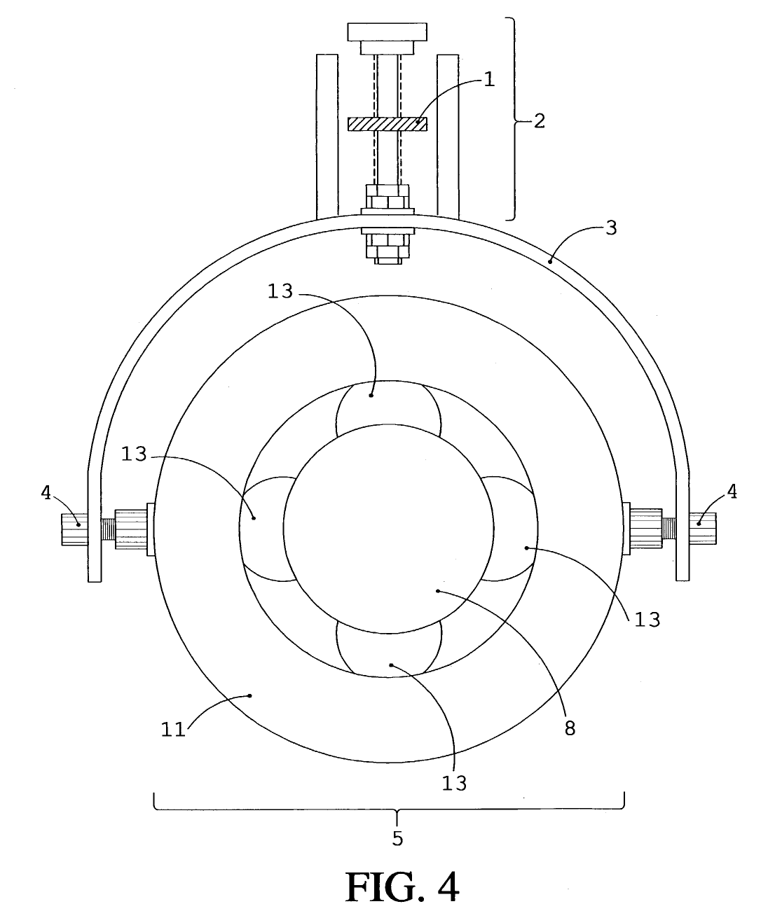

FIG. 4 depicts the ear or left side view of one typical headphone or earmuff assembly as established in FIG. 2. This ear or left side view FIG. 4 depicts: one aluminum connector bar 1, one pivoting headphone adjustment assembly 2, one headphone mounting bracket 3, two pivoting bracket to headphone connection assembly 4 and one speaker assembly 8 (for headphones only). All of which is considered prior art.

This ear or left side view FIG. 4 also depicts the present invention used in one typical headphone or earmuff unit 5. This includes one stationary headphone enclosure assembly 11 and the holes in the stationary headphone enclosure assembly 13 in which outside sound passes through to the ear.

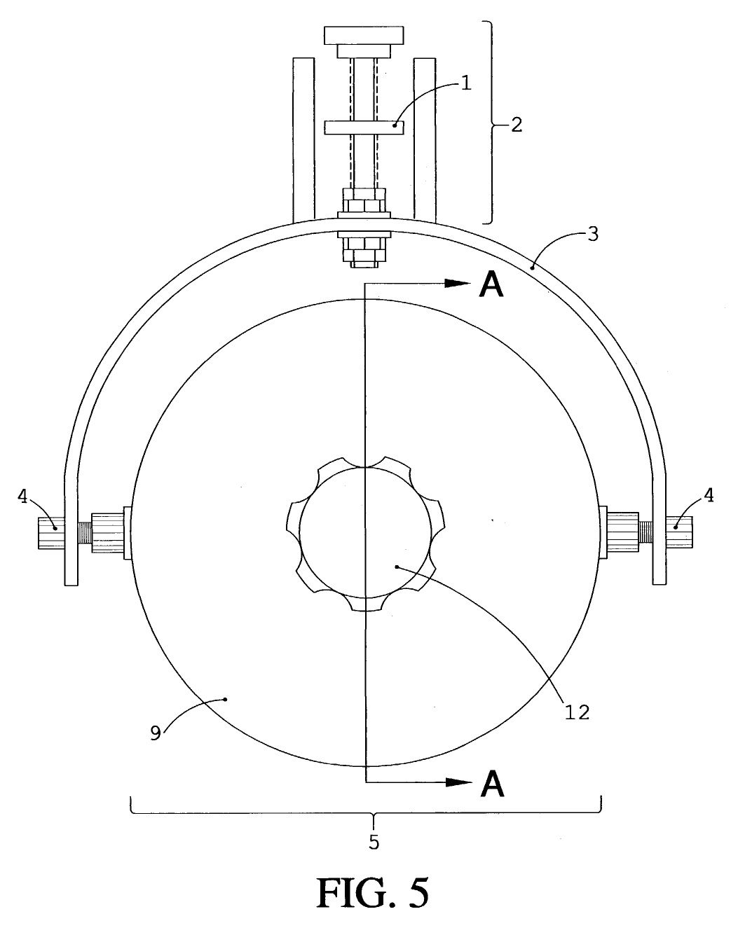

FIG. 5 depicts the exterior or right side view of one typical headphone or earmuff assembly as established in FIG.2. This exterior or right side view FIG. 5 depicts: one aluminum connector bar 1, one pivoting headphone adjustment assembly 2, one aluminum headphone mounting bracket 3 and two pivoting bracket to headphone connection assemblies 4. All of which is considered prior art.

This exterior or right side view FIG. 5 also depicts the present invention used in one typical headphone or earmuff unit 5. This includes one movable headphone enclosure unit 9 and one plastic control knob 12.

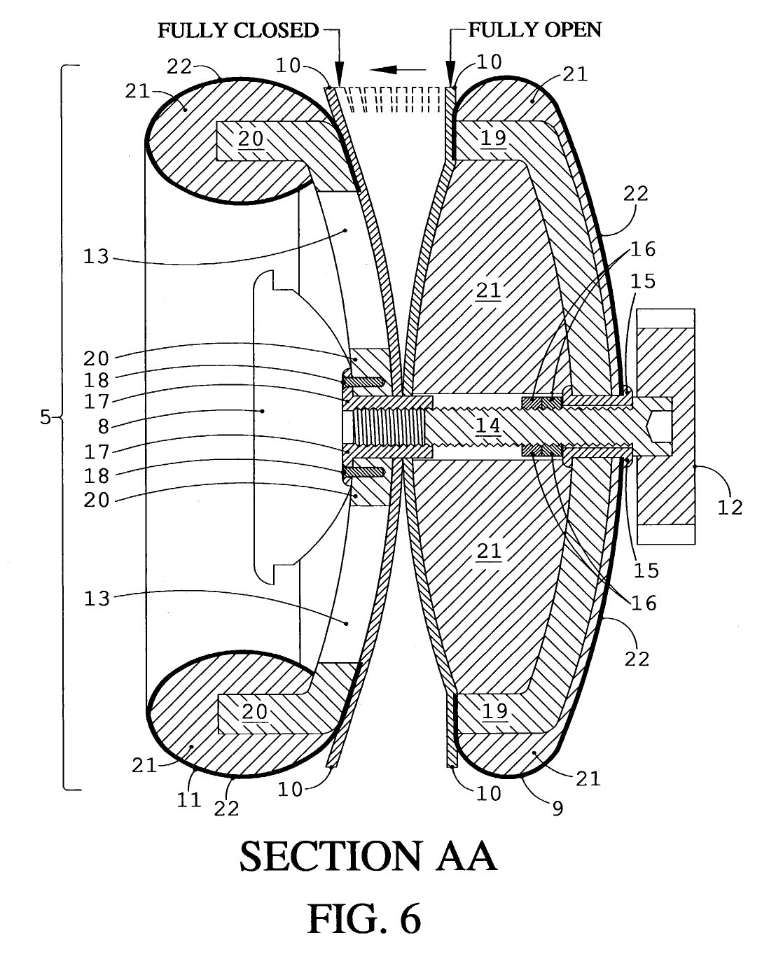

This exterior or right side view FIG. 5 also depicts the plane upon which the FIG. 6 sectional view AA is taken.

FIG. 6 depicts a sectional view labeled M of one typical headphone or earmuff unit 5 with the present invention as established in FIG. 5. This sectional view shows the present invention in the fully open position and depicts the mechanical parts and material composition of the present invention. The main components of one typical headphone or earmuff unit 5 include: one stationary headphone enclosure assembly 11, one movable headphone enclosure assembly 9, two foam rubber gaskets 10 and one plastic control knob 12.

The stationary headphone enclosure assembly 11 is worn over the ear of the user. It consists of one plastic (PVC) stationary headphone base 20 with four holes 13 drilled into the base. This allows for the transfer of sound to the ear of the user. There is also acoustic foam rubber padding 21 with a rubber coating 22 glued around the edge of the plastic (PVC) stationary headphone base 20. This gives the stationary headphone enclosure assembly 11 acoustic sound suppression and cushioning against the head of the user. There is also a threaded brass screw guide 17 connected to the enclosure unit with four counter sunk screws 18 (two of which are shown). If the present invention were used in a headphone application there would be a speaker 8 attached to the inside of the plastic (PVC) stationary headphone base 20. If the present invention were used as an earmuff hearing protection device then the speaker 8 would not be used.

The movable headphone enclosure assembly 9 consists of one plastic (PVC) movable headphone base 19. There is acoustic foam rubber padding 21 with a rubber coating 22 glued to the outside of the plastic (PVC) movable headphone base 19. There is also thick acoustic foam rubber padding 21 glued to the inside of the plastic (PVC) movable headphone base 19. This provides exterior sound suppression for the movable headphone enclosure assembly 9. There is also one brass screw guide 15 attached at the center of the plastic (PVC) movable headphone base 19. This protects the plastic (PVC) movable headphone base 19 from wear and tear caused by friction from the turning of the socket head cap screw 14.

The socket head cap screw 14 is connected to the plastic control knob 12 at the head of the screw. The movable headphone enclosure assembly 9 is connected to the socket head cap screw 14 through the brass screw guide 15 and the two locking hex nuts 16. A slight gap is provided between the locking hex nuts 16 and the brass screw guide 15. This allows the socket head cap screw 14 to turn without turning the movable headphone enclosure assembly 9 while still being connected. The socket head cap screw 14 then screws into the stationary headphone enclosure assembly 11 through the threaded brass screw guide 17. This allows the two enclosure assemblies to separate and un-separate incrementally by turning the plastic control knob 12. There are also two foam rubber control gaskets 10 between the two enclosures one of which is glued to each enclosure. This allows for a tight seal when the enclosures are in the fully closed position. The foam rubber control gaskets 10 are also glued together at the threaded brass screw guide 17. This allows the movable headphone enclosure assembly 9 to separate or un-separate from the stationary headphone enclosure assembly 11, but not rotate when the plastic control knob 12 is turned.

What I claim as my invention is:

1. A headphone or earmuff unit comprising:
A mechanical device that controls the amount of outside sound entering the headphone device thus controlling the amount of exterior sound heard by the ear of the user.

2. The headphone or earmuff according to claim 1, wherein said mechanical device comprises:
Two separate acoustically padded enclosures connected by a screw mechanism with a knob that when turned incrementally separates the enclosures to allow outside sound to enter the headphone or earmuff in a controlled manner.
